(19) United States
(12) Patent Application Publication
(10) Pub. No.: US 2002/0024182 A1
(43) Pub. Date: Feb. 28, 2002

(54) Atmospheric seal assembly for a rotating vessel

(76) Inventors: Edgard Matrak, Tonawanda, NY (US); David M. Bencic, Batavia, NY (US)

Correspondence Address: ARTHUR S. COOKFAIR, 5792 MAIN STREET, WILLIAMSVILLE, NY, 14221, US

(21) Appl. No.: 09/923,940

(22) Filed: Aug. 7, 2001

Related U.S. Application Data
(60) Provisional application No. 60/224,429, filed on Aug. 11, 2000.

(51) Int. Cl. F16J 15/34

(52) U.S. Cl. 277/377

(57) ABSTRACT

An atmospheric seal assembly for sealing the junction between a rotating tube kiln and a stationary hood comprises a multiplicity of spring-loaded cam follower clamping devices pressing a stationary graphite ring, extending from the hood, against a flange on the rotating tube kiln to provide a rotary seal by slidable contact between the rotating flange and the graphite ring and a second, flexible, seal extending from the hood to the first seal.

### CROSS-REFERENCE TO RELATED APPLICATIONS

This application claims the benefit of U.S. Provisional Patent Application Number 60/224,429, filed Aug. 11, 2000, entitled Seal for Rotary Tube furnace. The disclosure of this application is totally incorporated herein by reference.

### FIELD OF THE INVENTION

The present invention relates to the field of atmospheric or vapor seals and more particularly, to a seal assembly utilized to seal the junction between a rotating vessel and a stationary fixture.

### BACKGROUND

Rotary furnaces or kilns are commonly employed, either in a batch process or a continuous process for the treatment, such as drying or calcining or treatment with reactive gases, of particulate solids, for example sand, gravel, stone, fertilizers, metal oxide, pigments, various powders and the like. In a continuous process, an elongated drum or kiln, inclined slightly from the horizontal, is rotated, while the particulate solid to be treated is fed into one end, passes through the rotating drum or kiln and the treated material is discharged at the other end. During passage, the particulate solid may be contacted with either inert or reactive gas or gases, to cause the drying, calcining or other treatment of the solids.

In addition to the processing of materials at very high temperatures, such as temperatures ranging from 1500° C. to 3000° C., rotary furnace or kiln operations often require the containment of a selected atmosphere within the furnace during rotation. Also, in some operations, the leakage of gas from the kiln may be hazardous and deleterious to an operation as well as to the health and safety of workers. Furthermore, the infiltration of air from the surrounding atmosphere into the rotary kiln may be detrimental to the process or possibly even hazardous. Often in a continuous process, the discharged product is moved into a stationary hood or other fixed processing equipment.

The potential for vapor/gas escape or infiltration increases at the juncture of the rotating tube and the fixed processing equipment immediately downstream.

It is known in the art to employ graphite rings as seals at the ends of rotary tubes to prevent the leakage of gas. However, continual expansion and contraction associated with kiln temperature cycles may affect the integrity of the seal resulting in the development of gas leaks. Seal integrity may be affected by the axial load placed against the ring seal by the expansion of the rotary furnace while under higher temperatures. Seal integrity may be further adversely affected by uneven wear of the ring seal at the mating surface of the rotating tube. Uneven wear of the seal can lead to the escape of potentially harmful internal furnace gas into the surrounding atmosphere or allow external air to enter the furnace, possibly causing damage to the product or process as well as creating possible safety hazards.

Thus, there is a need for an atmospheric or vapor seal apparatus or assembly that is flexible enough to maintain seal integrity at the junction of a rotating tube and static fixture throughout the temperature cycles experienced in typical rotary kiln operation.

Atmospheric seal systems for use between rotating and stationary members, such as a rotating tube kiln and a stationary hood, are disclosed in co-pending application entitled MULTI-AXIS ROTARY SEAL SYSTEM, filed of even date herewith, the disclosure of which is totally incorporated herein by reference.

### SUMMARY OF THE INVENTION

It is an object of the invention to provide a system for the atmospheric sealing of a rotating vessel during its operation.

It is a second object of the invention to provide a novel clamping device suitable for maintaining a seal between a rotating device and a stationary surface.

It is a further object of the invention to provide an apparatus for maintaining the integrity of a seal between a rotating surface and a stationary surface.

It is an additional object to provide an apparatus for maintaining the integrity of a ring seal on a rotary tube furnace or kiln during expansion and contraction of the rotary tube as a result of temperature cycle.

Still another object of the invention is to provide a clamping device suitable for holding a stationary ring seal, such as a graphite ring seal, against a rotating tube component.

The present invention comprises an atmospheric sealing assembly suitable for sealing the junction between a rotating vessel, such as a rotary tube kiln, and a stationary fixture such as a vapor hood. The sealing assembly includes a multiplicity of spring-loaded cam-follower clamping devices that provide a clamping pressure on a rotating flange, radially extending from a wall of the rotating vessel and a stationary seal ring, such as a graphite ring, to provide a seal between the rotating vessel and the stationary seal ring. The cam-follower clamping device comprises a cam-follower which, in use, is rotatably pressed against a side of the rotating flange opposite another side of the flange that slidably engages the seal ring; and an opposing spring which presses against a surface of a structural mounting ring opposite another surface of the mounting ring that is attached to the stationary seal ring, maintaining the rotating flange and stationary seal ring in slidable engagement and providing a vapor tight seal at this juncture of the seal ring and flange. The number of cam-follower clamping devices will be from two to about twelve or more depending on the circumference of the rotatable vessel. A typical installation will include from about six to ten of the cam-follower clamping devices, evenly spaced around the circumference of the flange.

The atmospheric seal assembly of the present invention may be installed at either or both ends of a rotatable vessel, such as a rotary tube kiln.

The rotatable vessel may be comprised of various materials depending, for example, on the temperatures and other conditions, to which it may be subjected and the nature of the solid and gaseous materials with which it may be used. Typically, the rotary tube and flange, and structural ring are comprised of a heat and chemically resistant material, such as stainless steel or high temperature alloy. Other examples of materials include plastic, aluminum, and various other metals, such as carbon steel, and the like. The seal ring is preferably a graphite ring. However, depending on conditions of use, such as temperature, other low friction materials, such as polytetrafluoroethylene or the like may be used. The perpendicularity of the tube flange and the sealability of its surface with the graphite ring may be assured by machining the mating surface of the flange, that is, the surface that contacts the stationary graphite ring to form a seal. The graphite allows the tube to rotate with little drag and maintains a tight, or substantially tight seal, that will prevent the passage of gas into or out of the kiln. The O-rings are typically made of an elastomeric material, such as rubber or silicone. The flange may be at the end of the rotary tube, but will typically positioned a short distance back from the end. The end of the tube will then pass through the graphite ring, structural ring, and flexible seal and enter the hood.

### BRIEF DESCRIPTION OF THE DRAWINGS

FIG. 1 is a side view of an embodiment of the atmospheric seal assembly of the present invention installed at the end of a rotary tube.

FIG. 2 is an enlarged cross-sectional view of the atmospheric seal assembly embodiment shown in FIG. 1.

FIG. 3 is a cross-sectional view of an alternate embodiment of the atmospheric seal assembly of the present invention.

### DETAILED DESCRIPTION OF THE INVENTION

The present invention is an atmospheric seal assembly that enables the user to both contain a desired process atmosphere within the junction between a rotating vessel and a stationary fixture or machine, as well as prevent unwanted gas or atmospheric contamination from entering the sealed system through the rotational-stationary junction.

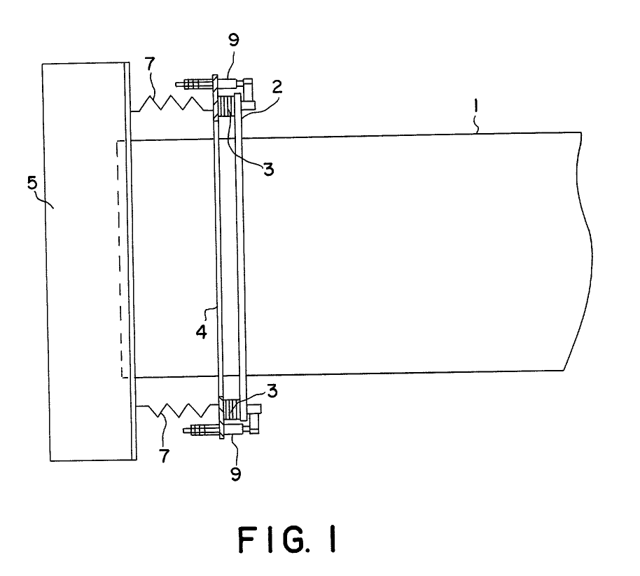

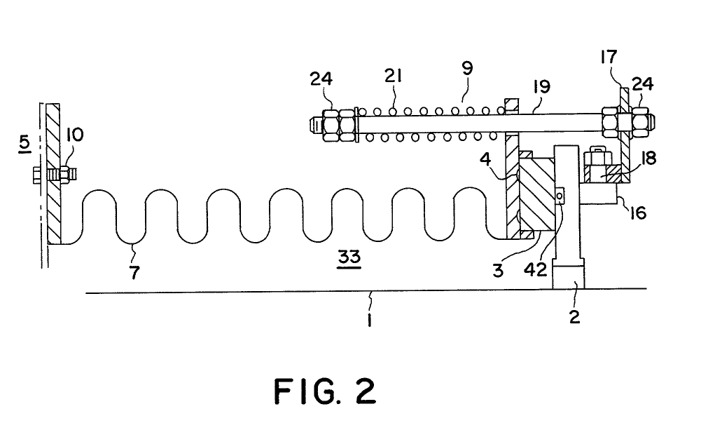

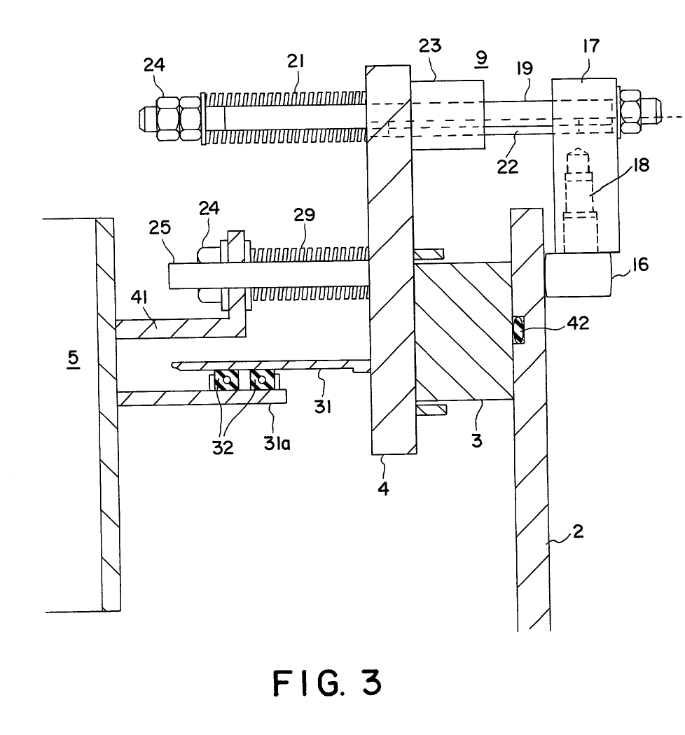

With reference to FIG. 1, which is a side view of an embodiment of the atmospheric seal assembly of the present invention installed at the end of a rotary tube, there is provided an atmospheric seal between rotary tube 1 and stationary hood 5. In the embodiment depicted, bellows 7 is attached at one end to a stationary hood 5 and at the other end to structural mounting ring 4. Bellows 7 may be secured to the ring 4 and the hood 5 by any of a variety of attachment means, such as bolts, clamps, welds, and the like. A graphite ring 3 is attached to the opposite side of structural mounting ring 4. The graphite ring 3 is pressed against flange 2 of rotary tube 1 by means of a multiplicity of spring-loaded cam-follower clamping devices 9 which provides a clamping pressure against flange 2 one side and structural mounting ring 4 on the other side, pressing graphite ring 3 into slidable engagement with flange 2 as rotary tube 1 and flange 2 rotate. The cam-follower clamping device 9 is depicted in greater detail in FIGS. 2 and 3.

FIG. 2 sets forth an enlarged cross-sectional view of the atmospheric seal assembly embodiment shown in FIG. 1. In the embodiment depicted, structural mounting ring 4 having graphite seal ring 3 attached thereto, is attached to and supported by bellows 7. The other end of bellows 7 is secured, for example, by nut and bolt means 10 to stationary hood 5. Spring-loaded cam-follower clamping device 9 includes a cam-follower 16 rotatably pressed on one side against flange 2 and a compression spring 21 pressed against the stationary structural mounting ring 4 on the other side. Cam-follower 16 is rotatably attached to cam-follower guide 17 through rotatable connection 18. Clamping rod 19 supports compression spring 21 and is fixedly attached at one end to cam-follower guide 17. At the other end of clamping rod 19, nuts 24 hold spring 21 in place and provide a means for adjusting tension on spring 21 and resultant pressure against structural mounting ring 4 and attached graphite ring 3. As stationary graphite ring 3 is slidably pressed against rotating flange 2 a rotary atmospheric seal is formed. It can be seen that the components of the assembly described above define a space 33 bounded by rotating tube 1, stationary hood 5 and bellows 7. During operation, as space 33 expands and contracts, due to temperature cycling, bellows 7 expands and contracts, and the compressive force of spring 21 forces graphite ring 3 into slidable engagement with rotating flange 2, forming a rotating seal and maintaining the integrity of enclosed space 33.

FIG. 3 sets forth an alternate embodiment of the atmospheric seal assembly of the present invention. The seal assembly depicted utilizes a preferred embodiment of the cam-follower clamping device 9 to provide the clamping pressure to hold graphite ring 3 in slidable contact with flange 2 of rotary tube 1. In this embodiment, clamping rod 19 passes through guide bushing 23 on one side of structural mounting ring 4 and is splinably attached to guide bushing 23 by key 22. As it passes through the above-mentioned components, clamping rod 19 may be fixedly attached by any of several means known in the art, such as clips, pins, or welds. Preferably clamping rod 19 is a threaded rod that is held in place using nuts 24. In this embodiment, the flexible seal is formed by movable sleeves 31 and 31a attached to the structural mounting ring 4 and stationary hood 5 respectively. The sleeves enclose one or more O-rings 32 to ensure seal integrity as sleeves 31 and 31a slide, in a telescopic manner in response to expansion and contraction of the rotary tube due to temperature changes. Furthermore, in this embodiment, the structural mounting ring 4 is supported by two or more supports 41 attached at one end to stationary hood 5 and at the other end, in a compression responsive manner, through rod 25 and compression spring 29. The use of compression spring 29 in the support allows for horizontal movement of the structural mounting ring 4 due to expansion and contraction of the rotating tube 1 resulting from temperature fluctuations.

In operation, the graphite ring and the mating surface of the rotating tube may wear unevenly over time allowing the internal gas to escape to the atmosphere or atmospheric air to enter. To compensate for uneven wear, in a preferred embodiment, an O-ring 42 is installed in a groove facing the graphite ring 3, for example in flange 2, as shown in FIGS. 2 and 3. As the graphite ring wears, the O-ring 42 will expand and fill the gap and prevent internal gas from escaping and atmospheric air from entering. The O-ring 42 may be of solid form or tubing form is preferably made of an elastomeric material such as silicone or rubber.

Although the invention has been described with reference to certain preferred embodiments, it will be appreciated by those skilled in the art that modifications and variations may be made without departing from the spirit and scope of the invention as defined in the appended claims.

What is claimed is:

1- An atmospheric seal assembly for sealing the junction between a rotatable vessel and a stationary fixture comprising:
A) a flange extending from said rotatable vessel;
B) a stationary structural ring having a seal ring attached one side thereof, said structural ring and seal ring surrounding said rotatable vessel and said seal ring in slidable contact with one side of said flange;
C) a multiplicity of spring-loaded cam-follower clamping devices, each comprising a cam-follower rotatably pressed against an opposite side of said flange and an opposing spring pressing against said structural ring, said structural ring, in turn, pressing said seal ring against said flange to maintain a continuous slidable engagement of said seal ring and said flange during rotation of said rotatable vessel;
D) a flexible enclosure extending from said stationary structural ring to said stationary fixture.

2- An atmospheric seal assembly according to claim 1 wherein said seal ring is a graphite ring.

3- An atmospheric seal assembly according to claim 2 wherein said flexible enclosure is a bellows attached at on end to said structural ring and at another end to said stationary fixture.

4- An atmospheric seal assembly according to claim 2 wherein said flexible enclosure comprises a first tubular sleeve extending from said structural ring and a second tubular sleeve extending from said stationary fixture, said first and second sleeves being in a telescopic relationship with an annular space therebetween, said annular space being sealed by at least one O-ring.

5- An atmospheric seal assembly according to claim 2 wherein said stationary fixture is a vapor hood.

6- An atmospheric seal assembly according to claim 5 wherein said flange includes a groove containing an O-ring facing said graphite ring.

7- An atmospheric seal assembly according to claim 5 wherein said flexible enclosure is a bellows attached at one end to said structural ring and at another end to said vapor hood.

8- An atmospheric seal assembly according to claim 5 wherein said flexible enclosure comprises a first tubular sleeve extending from said structural ring and a second tubular sleeve extending from said stationary fixture, said first and second sleeves being in a telescopic relationship with an annular space therebetween, said annular space being sealed by at least one O-ring.
